(19) United States
(12) Patent Application Publication
(10) Pub. No.: US 2015/0243210 A1
(43) Pub. Date: Aug. 27, 2015

(54) ORGANIC LIGHT EMITTING DISPLAY AND METHOD FOR DRIVING THE SAME

(71) Applicant: SAMSUNG DISPLAY CO., LTD., Yongin-City (KR)

(72) Inventors: Dong-Won PARK, Yongin-City (KR); Jae-Hoon LEE, Yongin-City (KR); Kyung-Hoon KIM, Yongin-City (KR); Jung-Taek KIM, Yongin-City (KR); Bong-Hyun YOU, Yongin-City (KR)

(21) Appl. No.: 14/610,276

(22) Filed: Jan. 30, 2015

(30) Foreign Application Priority Data
Feb. 26, 2014 (KR) 10-2014-0022507

(51) Int. Cl. G09G 3/32

(52) U.S. Cl. CPC G09G 3/3208; G09G 2320/0233; G09G 2360/16; G09G 2320/064

(57) ABSTRACT

An organic light emitting display includes a plurality of pixels and a timing controller. The timing controller accumulates emission luminance values during a plurality of frames. The timing controller then supplies a reset signal to the pixels to respectively set non-emission periods for a plurality of subfields when the accumulated emission luminance value exceeds a reference value.

### CROSS-REFERENCE TO RELATED APPLICATION

Korean Patent Application No. 10-2014-0022507, filed on Feb. 26, 2014, and entitled, “Organic Light Emitting Display and Method for Driving the Same,” is incorporated by reference herein in its entirety.

### BACKGROUND

1. Field

One or more embodiments described herein relate to an organic light emitting display and a method for driving the same.

2. Description of the Related Art

A variety of flat panel displays have been developed. Examples include liquid crystal displays, field emission displays, plasma display panels, and organic light emitting displays. Among these, organic light emitting displays use organic light emitting diodes to generate an image. In operation, the organic light emitting diodes emit light based on a recombination of electrons and holes. This type of display has fast response speed and low power consumption.

### SUMMARY

In accordance with one embodiment, an organic light emitting display includes a plurality of pixels and a timing controller configured to accumulate emission luminance values during a plurality of frames, and to supply a reset signal to the pixels to respectively set non-emission periods for a plurality of subfields when the accumulated emission luminance value exceeds a reference value.

The non-emission period may gradually increase while the accumulated emission luminance value exceeds the reference value. The timing controller may include an accumulation unit configured to generate an accumulation value by accumulating the emission luminance values during the plurality of frames; a comparison unit configured to generate a luminance reduction control signal when the accumulation value exceeds the reference value; and a reset signal generation unit to generate the reset signal in response to the luminance reduction control signal.

The reset signal generation unit may increase the pulse width of the reset signal in proportion to a maintenance period of the luminance reduction control signal. The reset signal may be periodically toggled. The reset signal generation unit may increase the frequency of the reset signal in proportion to a maintenance period of the luminance reduction control signal.

Each of the pixels may include an organic light emitting diode; a storage capacitor; a scan transistor to turn on when a scan signal is supplied to a scan line, the scan transistor to allow a voltage of a first or second voltage level, corresponding to a data signal supplied to a data line, to charge in the storage capacitor; a driving transistor to turn on when the storage capacitor charges to the voltage of the first voltage level, a driving current supplied to the organic light emitting diode when the driving transistor turns on; and a reset transistor to turn off in response to the reset signal, the driving current to cut off when the reset transistor turns off.

Each of the pixels may include an organic light emitting diode; a storage capacitor; a scan transistor to turn on when a scan signal is supplied to a scan line, to charge a storage capacitor to a first or second voltage level corresponding to a data signal supplied to a data line; a driving transistor to turn on when the storage capacitor charges to the first voltage level, the driving transistor to supply driving current to the organic light emitting diode; and a reset transistor to turn on in response to the reset signal to discharge the storage capacitor.

In accordance with another embodiment, a method for driving an organic light emitting display includes accumulating emission luminance values during a plurality of frames to generate an accumulation value; comparing the accumulation value with a reference value; and respectively setting non-emission periods for a plurality of subfields when the accumulation value exceeds the reference value.

The non-emission period may gradually increase while the accumulation value exceeds the reference value. Setting the non-emission periods may include supplying a reset signal to a pixel, the reset signal having a pulse width corresponding to the non-emission period. The pulse width of the reset signal may increase in proportion to a period in which the accumulation value exceeds the reference value.

Setting the non-emission periods may include supplying a reset signal to a pixel, the reset signal toggled at a frequency corresponding to the non-emission period. The frequency of the reset signal may increase in proportion to a period in which the accumulation value exceeds the reference value.

In accordance with another embodiment, a pixel includes a driving transistor; and a reset transistor coupled to the driving transistor, wherein the reset transistor is to control a flow of current from the driving transistor to an organic light emitting diode based on a reset signal, the reset transistor to block the flow of current when the reset signal has a first value and to allow the current to flow when the reset signal has a second value, the reset signal to have the first value when an accumulated emission luminance value is in a first range and to have the second value when the accumulated emission luminance value is in a second range different from the first range.

A time when the reset transistor is to block the flow of current may correspond to a non-emission period, and the reset transistor may control a duration of a non-emission period in each of a plurality of subfields in one frame. The durations of the non-emission periods in the subfields of the one frame may be different. The durations of the non-emission periods in the subfields may be based on durations of respective ones of the subfields.

The accumulated emission luminance value may be in the first range when the accumulated emission luminance value exceeds a reference value, and the accumulated emission luminance value may be in the second range when the accumulated emission luminance value is less than the reference value. The accumulated emission luminance value may be based on luminance values accumulated over a plurality of frames.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light emitting display;

FIG. 2 illustrates an embodiment of a timing controller;

FIG. 3 illustrates an embodiment of a pixel;

FIG. 4 illustrates an embodiment of a control signal for the pixel;

FIG. 5 illustrates another embodiment of a control signal for the pixel;

FIG. 6 illustrates another embodiment of a pixel; and

FIG. 7 illustrates an embodiment of a control signal for the pixel in FIG. 6.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing, the dimensions of regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

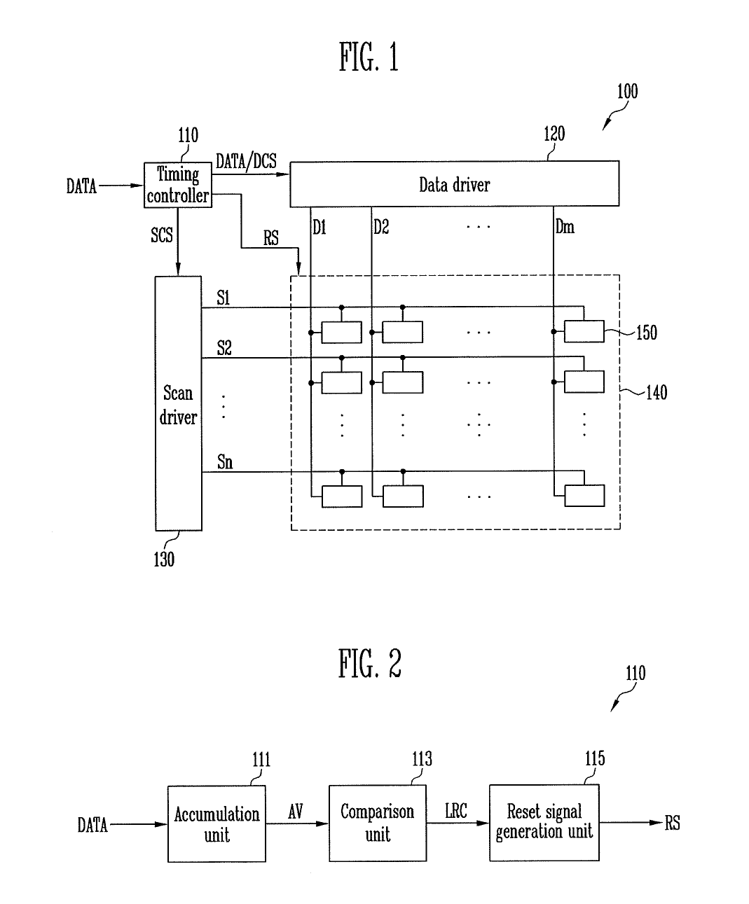

FIG. 1 illustrates an embodiment of an organic light emitting display, and FIG. 2 illustrating an embodiment of a timing controller in FIG. 1.

Referring to FIGS. 1 and 2, the organic light emitting display 100 includes a timing controller 110, a data driver 120, a scan driver 130 and a display unit 140. The timing controller 110 controls operations of the data driver 120 and the scan driver 130, in response to a synchronization signal supplied from an external source, e.g., an application processor of a host. For example, the timing controller 110 generates a data driving control signal DCS for input into the data driver 120. The timing controller 110 generates a scan driving control signal SCS for input into the scan driver 130.

The timing controller 110 supplies image data DATA supplied from an external source to the data driver 120, in synchronization with the data driving control signal DCS and the scan driving control signal SCS.

The timing controller 110 controls the data driver 120 and the scan driver 130, so that one frame is divided into a plurality of subfields. Each pixel 150 emits light during a predetermined number (e.g., some of) the subfields based on the image data DATA.

When the pixels 150 emit light with a high luminance during a plurality of frames, the timing controller 110 sets a non-emission period with respect to each of the plurality of subfields, so that organic light emitting diodes and transistors in the pixels 150 are not degraded. The non-emission period with respect to each of the subfields may be in proportion to the length of the subfield.

For example, the timing controller 110 accumulates emission luminance values during a plurality of frames, and supplies a reset signal to the pixels 150 for setting a non-emission period with respect to each of the subfields when the accumulated emission luminance value exceeds a reference value. The emission luminance value may be a value corresponding to one or more gray scale values of the pixels 150 during one frame.

The timing controller 110 includes an accumulation unit 111, a comparison unit 113 and a reset signal generation unit 115. The accumulation unit 111 accumulates emission luminance values during a plurality of frames and generates an accumulation value AV. For example, the accumulation unit 111 calculates an emission luminance value with respect to each of the plurality of frames in response to the image data DATA, and accumulates the calculated emission luminance values to thereby generate an accumulation value AV. The accumulation unit 111 outputs the accumulation value AV to the comparison unit 113.

The comparison unit 113 compares the accumulation value AV with a reference value, and outputs a luminance reduction control signal LRC to the reset signal generation unit 115 when the accumulation value AV exceeds the reference value.

The reset signal generation unit 115 outputs a rest signal RS to the pixels 150, so that the pixels 150 do not emit light, in response to the luminance reduction control signal LRC from the comparison unit 113. The reset signal generation unit 115 outputs the reset signal RS to the pixels 150 for each subfield.

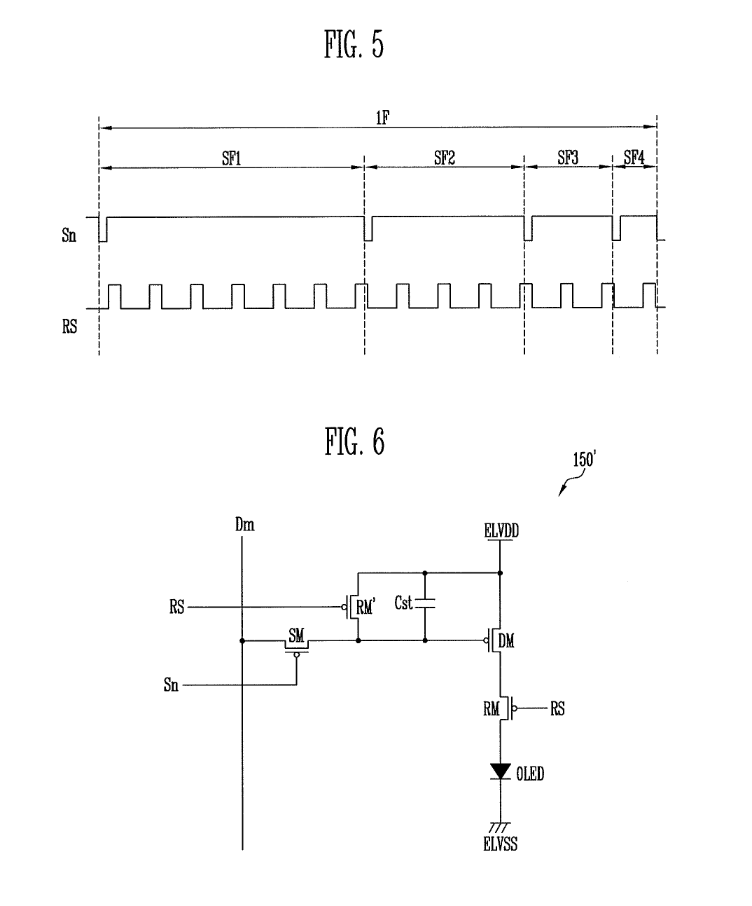

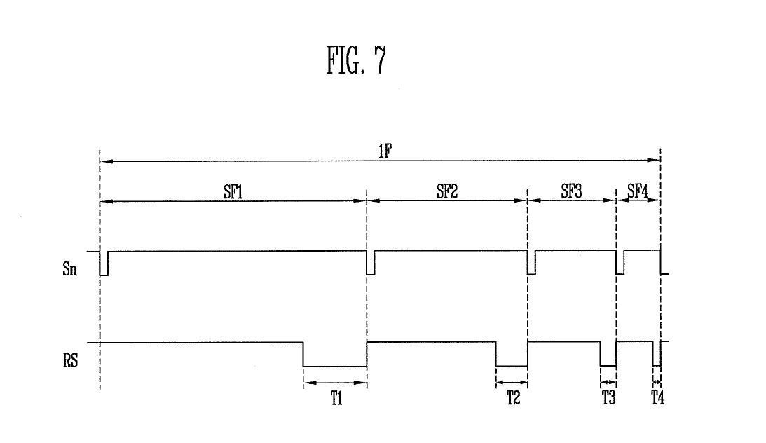

In one embodiment, output or supply of the reset signal RS to the pixels 150 includes controlling the pixels 150 not to emit light. The voltage level of the reset signal RS may have different values in different embodiments. For example, in FIGS. 3 to 5, the pixels 150 do not emit light when the reset signal RS is at a high level. In this case, when the reset signal RS is at the high level, the reset signal RS is output or supplied. In another embodiment, such as in FIGS. 6 and 7, the pixels 150 do not emit light when the reset signal RS is at a low level. In this case, the reset signal RS is output or supplied when the reset signal RS is at the low level.

According to one embodiment, the reset signal generation unit 115 supplies the reset signal RS to the pixels 150 in a latter portion (e.g., latter half portion) of each of the plurality of subfields. In this case, the reset signal generation unit 115 increases the pulse width of the reset signal RS in proportion to the maintenance period of the luminance reduction control signal LRC.

According to another embodiment, the reset signal generation unit 115 may perform a toggle operation relative to the pixels 150, e.g., the reset signal RS may continuously change between high and low levels. In this case, the reset signal generation unit 115 may increase the frequency of the reset signal RS in proportion to the maintenance period of the luminance reduction control signal LRC. Also, in this case, the pulse width of the reset signal RS (e.g., the period in which the reset signal RS is at the high level) is equally maintained. Therefore, as the frequency of the reset signal RS increases, the luminance of the pixel 150 decreases.

The data driver 120 supplies, to data lines D1 to Dm, data signals corresponding to the image data DATA in response to the data driving control signal DCS from the timing controller 110. For example, the data driver 120 supplies the data signals to the data lines D1 to Dm, so that each pixel 150 emits or does not emit light for each of the plurality of subfields.

The scan driver 130 sequentially supplies a scan signal to scan lines S1 to Sn in response to the scan driving control signal SCS from timing controller 110. For example, the scan driver 130 supplies the scan signal to the pixels 150 for each of the plurality of subfields through the scan lines S1 to Sn.

Although it has been illustrated in FIG. 1 that the timing controller 110, the data driver 120, and the scan driver 130 are separate components, in other embodiments the timing controller 110, the data driver 120, and the scan driver 130 may be implemented in one integrated circuit.

The display unit 140 includes pixels 150 respectively disposed at intersection portions of the data lines D1 to Dm and the scan lines S1 to Sn. The data lines D1 to Dm are arranged in a vertical direction, and the scan lines S1 to Sn are arranged in a horizontal direction, or vice versa.

Each pixel 150 is coupled to a corresponding data line among the data lines D1 to Dm and a corresponding scan line among the scan lines S1 to Sn. Each pixel emits or does not emit light based on the voltage level of a data signal supplied through the corresponding data line, while a scan signal is being supplied through the corresponding scan line. Each pixel 150 does not emit light while the reset signal RS is being supplied.

FIG. 3 illustrates an embodiment of a pixel, which, for example, may correspond to the pixels in FIG. 1. Referring to FIG. 3, the pixel 150 includes an organic light emitting diode OLED, a storage capacitor Cst, and transistors SM, DM and RM.

The organic light emitting diode OLED is coupled between a second electrode of a reset transistor RM and a second power source ELVSS. For example, an anode electrode of the organic light emitting diode OLED is coupled to the second electrode of the reset transistor RM, and a cathode electrode of the organic light emitting diode OLED is coupled to the second power source ELVSS. The organic light emitting diode OLED emits light in response to driving current flowing from a first power source ELVDD to the second power source ELVSS through a driving transistor DM and the reset transistor RM.

The storage capacitor Cst is coupled between the first power source ELVDD and a gate electrode of the driving transistor DM. For example, one end of the storage capacitor Cst is coupled to the first power source ELVDD and a first electrode of the driving transistor DM. The other end of the storage capacitor Cst is coupled to the gate electrode of the driving transistor DM and a second electrode of the scan transistor SM. The storage capacitor Cst charges to a voltage level corresponding to that of a data signal supplied through a data line Dm, when the scan transistor SM is turned on.

The scan transistor SM is coupled between the data line Dm and the driving transistor DM. The scan transistor SM is turned on when a scan signal is being supplied through a scan line Sn. For example, a gate electrode of the scan transistor SM is coupled to the scan line Sn and a first electrode of the scan transistor SM is coupled to the data line Dm. The second electrode of the scan transistor SM is coupled to the gate electrode of the driving transistor DM and the other end of the storage capacitor Cst.

The first electrode and the second electrode are source and drain electrodes. For example, when the first electrode is a source electrode, the second electrode is a drain electrode, and vice versa.

The scan transistor SM is turned on when the scan signal is supplied through the scan line Sn. When the scan transistor SM is turned on, the storage capacitor Cst is charged to a voltage of a first or second voltage level corresponding to the data signal supplied through the data line Dm.

The first voltage level may correspond to a voltage level for turning on the driving transistor Dm. The second voltage level may correspond to a voltage level for turning off the driving transistor Dm. For example, when the voltage of the first voltage level is charged in the storage capacitor Cst, a driving current for allowing the organic light emitting diode OLED to emit light flows from the first power source ELVDD to the second power source ELVSS through the organic light emitting diode OLED. The driving current does not flow when the voltage of the second voltage level is charged in the storage capacitor Cst.

The gate electrode of the driving transistor DM is coupled to the other end of the storage capacitor Cst and the second electrode of the scan transistor SM. The first electrode of the driving transistor DM is coupled to the first power source ELVDD and the first end of the storage capacitor Cst. A second electrode of the driving transistor DM is coupled to a first electrode of the reset transistor RM.

The driving transistor DM controls the driving current based on the voltage charged in the storage capacitor Cst. For example, the driving transistor DM is turned on when the voltage of the first voltage level is charged in the storage capacitor Cst. When the driving transistor DM is turned on at this time, driving current is supplied to the organic light emitting diode OLED. On the contrary, the driving transistor DM is turned off when the voltage of the second voltage level is charged in the storage capacitor Cst. When the driving transistor DM is turned off, the driving current is prevented from being supplied to the organic light emitting diode OLED.

The reset transistor RM is coupled between the driving transistor Dm and the organic light emitting diode OLED. The reset transistor RM is turned off in response to the reset signal RS. For example, a gate electrode of the reset transistor RM is coupled to a reset signal line through which the reset signal RS is supplied. The first electrode of the reset transistor RM is coupled to the second electrode of the driving transistor DM. The second electrode of the reset transistor RM is coupled to the anode electrode of the organic light emitting diode OLED.

The reset transistor RM is turned off in response to the reset signal RS. Turning off the reset transistor RM cuts off the driving current supplied to the organic light emitting diode OLED.

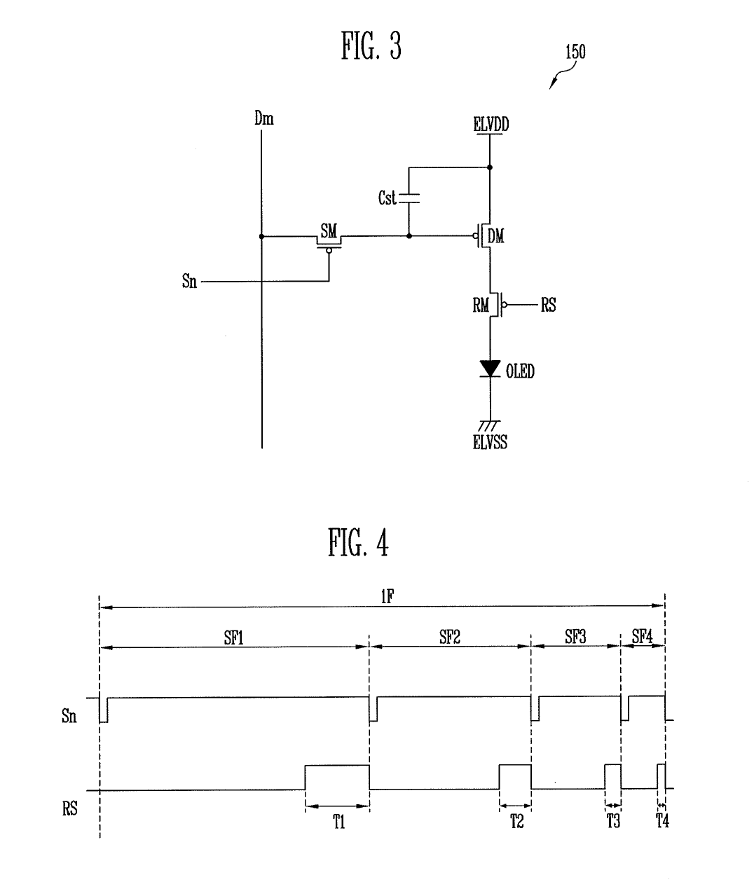

FIG. 4 is a timing of a control signal supplied to the pixel in FIG. 3 according to one embodiment. Although it has been illustrated in FIGS. 4, 5 and 7 that one frame 1F is configured with four subfields SF1 to SF4, a different number of subfields may be included in other embodiments. For example, one frame SF1 may be configured with two or more subfields.

Referring to FIG. 4, each of the subfields SF1 to SF4 is started as the scan signal is supplied to the scan line Sn. The storage capacitor Cst charges a voltage of the first or second voltage level corresponding to that of the data signal supplied through the data line Dm, when the scan signal is supplied to the scan line Sn. If the reset signal RS is not supplied to the pixel 150, the pixel 150 maintains an emission or non-emission state until a corresponding subfield is finished.

When the timing controller 110 supplies the reset signal RS to the pixel 150, the reset transistor RM cuts off the driving current supplied to the organic light emitting diode OLED. The pixel 150 does not emit light during periods T1 to T4 where the reset signal SR is supplied for each of the subfields SF1 to SF4. Therefore, the luminance of the pixel 150 decreases during one frame 1F.

The timing controller 110 controls the periods T1 to T4 where the reset signal RS is supplied for each of the subfields SF1 to SF4. The timing controller 110 controls the periods T1 to T4 in proportion to the length of each of the subfields SF1 to SF4. For example, the ratio among the periods T1 to T4 in which the reset signal RS is supplied may be based on or equal to that among the subfields SF1 to SF4.

The timing controller 110 gradually increases the periods T1 to T4 in which the reset signal RS is supplied, while the emission luminance value accumulated during a plurality of frames (e.g., the accumulation value AV) exceeds the reference value. For example, when a high gray-scale image is continuously displayed, the timing controller 150 operates to gradually decrease the luminance of the pixel 150.

FIG. 5 is a timing diagram illustrating another embodiment of the control signal supplied to the pixel in FIG. 3. The timing of the control signal shown in FIG. 5, ay be the same as in FIG. 4, except that the reset signal is toggled.

Referring to FIG. 5, when the reset signal RS is supplied (e.g., when the reset signal RS is in the high level), the reset transistor RM is turned off in order to cut off the driving current to the organic light emitting diode OLED. The luminance of the pixel 150 is therefore decreased depending on the frequency of the reset signal RS.

The number of times the reset signal RS is supplied with respect to each of the subfields SF1 to SF4 is in proportion to the length of each of the subfields SF1 to SF4. The timing controller 110 gradually increases the frequency of the reset signal RS, so that the luminance of the pixel 150 is gradually decreased while the accumulation value AV exceeds the reference value.

FIG. 6 illustrates another embodiment of a pixel 150′, which, for example, may correspond to the pixels in FIG. 1. The pixel 150′ in FIG. 6 may be the same as pixel 150 in FIG. 3, except that the pixel 150′ includes a reset transistor RM′ coupled between the ends of the storage capacitor Cst, rather than the reset transistor RM coupled between the driving transistor DM and the organic light emitting diode OLED.

Referring to FIG. 6, the pixel 150′ includes the organic light emitting diode OLED, the storage capacitor Cst, and the transistors SM, DM and RM′. The reset transistor RM′ is coupled between the ends of the storage capacitor Cst. The reset transistor RM′ is turned on in response to the reset signal RS. For example, a gate electrode of the reset transistor RM′ is coupled to the reset signal line through which the reset signal RS is supplied. A first electrode of the reset transistor RM′ is coupled to one end of the storage capacitor Cst and the first power source ELVDD. A second electrode of the reset transistor RM′ is coupled to the other end of the storage capacitor Cst, the second electrode of the scan transistor SM, and the gate electrode of the driving transistor DM. The reset transistor RM′ is turned on in response to the reset signal RS, in order to discharge the storage capacitor Cst.

FIG. 7 is a timing diagram illustrating a control signal supplied to the pixel in FIG. 6 according to one embodiment. The timing of the control signal in FIG. 7 may be the same as in FIG. 4, except that the voltage level of the reset signal RS is reversed.

Referring to FIG. 7, when the reset signal RS is supplied (e.g., when the reset signal RS is in the low level), the reset transistor RM′ is turned on. When the reset transistor RM′ is turned on, the voltages at the ends of the storage capacitor Cst become equal to each other. As such, if the storage capacitor Cst is discharged, the driving transistor DM is turned off. That is, if the reset signal RS is supplied, the pixel 150 does not emit light. In addition, the pixel 150 maintains the non-emission state until before the storage capacitor Cst charges the voltage of the first voltage level.

The pixel 150 does not emit light during the periods T1 to T4 in which the reset signal RS is supplied for each of the subfields SF1 to SF4. Therefore, the luminance of the pixel 150 decreases during the one frame 1F.

According to one embodiment, the organic light emitting display 100 may include a power supply unit which accumulates emission luminance values during a plurality of frames and regulates the voltage of the first or second power source ELVDD or ELVSS. This is performed so that the non-emission period is set with respect to each of the plurality of subfields when the accumulated emission luminance value exceeds the reference value.

The non-emission period corresponding to the length of each of the plurality of subfields is therefore set for each of the plurality of subfields. As a result, the luminance of the pixel may be decreased while maintaining the ability to express gray scale values.

By way of summation and review, the organic light emitting diodes and transistors in an organic light emitting display degrade over time. As a result, a difference in luminance among pixels may occur. This may cause, for example, a luminance spot to be generated as a result of the difference in luminance between the pixels, thereby deteriorating image quality.

In accordance with one or more of the aforementioned embodiments, the luminance of the pixel may be reduced while gray scale expression ability is maintained. As a result, degradation of the organic light emitting diodes and the transistors may be prevented without any deterioration in image quality.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An organic light emitting display, comprising:
a plurality of pixels; and
a timing controller configured to accumulate emission luminance values during a plurality of frames, and to supply a reset signal to the pixels to respectively set non-emission periods for a plurality of subfields when the accumulated emission luminance value exceeds a reference value.

2. The display as claimed in claim 1, wherein the non-emission period gradually increases while the accumulated emission luminance value exceeds the reference value.

3. The display as claimed in claim 1, wherein the timing controller includes:
an accumulation unit configured to generate an accumulation value by accumulating the emission luminance values during the plurality of frames;
a comparison unit configured to generate a luminance reduction control signal when the accumulation value exceeds the reference value; and
a reset signal generation unit configured to generate the reset signal in response to the luminance reduction control signal.

4. The display as claimed in claim 3, wherein the reset signal generation unit increases a pulse width of the reset signal in proportion to a maintenance period of the luminance reduction control signal.

5. The display as claimed in claim 3, wherein the reset signal is periodically toggled.

6. The display as claimed in claim 5, wherein the reset signal generation unit increases a frequency of the reset signal in proportion to a maintenance period of the luminance reduction control signal.

7. The display as claimed in claim 1, wherein each of the pixels includes:
an organic light emitting diode;
a storage capacitor;
a scan transistor to turn on when a scan signal is supplied to a scan line, the scan transistor to allow a voltage of a first or second voltage level, corresponding to a data signal supplied to a data line, to charge in the storage capacitor;
a driving transistor to turn on when the storage capacitor charges to the voltage of the first voltage level, a driving current supplied to the organic light emitting diode when the driving transistor turns on; and
a reset transistor to turn off in response to the reset signal, the driving current to cut off when the reset transistor turns off.

8. The display as claimed in claim 1, wherein each of the pixels includes:
an organic light emitting diode;
a storage capacitor;
a scan transistor to turn on when a scan signal is supplied to a scan line, to charge a storage capacitor to a first or second voltage level corresponding to a data signal supplied to a data line;
a driving transistor to turn on when the storage capacitor charges to the first voltage level, the driving transistor to supply driving current to the organic light emitting diode; and
a reset transistor to turn on in response to the reset signal to discharge the storage capacitor.

9. A method for driving an organic light emitting display, the method comprising:
accumulating emission luminance values during a plurality of frames to generate an accumulation value;
comparing the accumulation value with a reference value; and
respectively setting non-emission periods for a plurality of subfields when the accumulation value exceeds the reference value.

10. The method as claimed in claim 9, wherein the non-emission period gradually increases while the accumulation value exceeds the reference value.

11. The method as claimed in claim 9, wherein setting the non-emission periods includes supplying a reset signal to a pixel, the reset signal having a pulse width corresponding to the non-emission period.

12. The method as claimed in claim 11, wherein the pulse width of the reset signal increases in proportion to a period in which the accumulation value exceeds the reference value.

13. The method as claimed in claim 9, wherein setting the non-emission periods includes supplying a reset signal to a pixel, the reset signal toggled at a frequency corresponding to the non-emission period.

14. The method as claimed in claim 13, wherein the frequency of the reset signal increases in proportion to a period in which the accumulation value exceeds the reference value.

15. A pixel, comprising:
a driving transistor; and
a reset transistor coupled to the driving transistor,
wherein the reset transistor is to control a flow of current from the driving transistor to an organic light emitting diode based on a reset signal, the reset transistor to block the flow of current when the reset signal has a first value and to allow the current to flow when the reset signal has a second value, the reset signal to have the first value when an accumulated emission luminance value is in a first range and to have the second value when the accumulated emission luminance value is in a second range different from the first range.

16. The pixel as claimed in claim 15, wherein:
a time when the reset transistor is to block the flow of current corresponds to a non-emission period, and
the reset transistor is to control a duration of a non-emission period in each of a plurality of subfields in one frame.

17. The pixel as claimed in claim 16, wherein the durations of the non-emission periods in the subfields of the one frame are different.

18. The pixel as claimed in claim 17, when the durations of the non-emission periods in the subfields are based on durations of respective ones of the subfields.

19. The pixel as claimed in claim 15, wherein:
the accumulated emission luminance value is in the first range when the accumulated emission luminance value exceeds a reference value, and
the accumulated emission luminance value is in the second range when the accumulated emission luminance value is less than the reference value.

20. The pixel as claimed in claim 15, wherein the accumulated emission luminance value is based on luminance values accumulated over a plurality of frames.
